(19) United States
(12) Patent Application Publication
(10) Pub. No.: US 2004/0030471 A1
(43) Pub. Date: Feb. 12, 2004

(54) Method and device for triggering a hybrid vehicle

(76) Inventor: Ian Faye, Stuttgart (DE)

Correspondence Address: KENYON & KENYON, ONE BROADWAY, NEW YORK, NY, 10004, US

(21) Appl. No.: 10/344,590

(22) PCT Filed: May 31, 2002
(86) PCT No.: PCT/DE02/01985

(30) Foreign Application Priority Data
Jun. 13, 2001 (DE) 10128758.5

(51) Int. Cl. G06F 17/00

(52) U.S. Cl. 701/22; 180/65.3

(57) ABSTRACT

A method and a device for triggering a hybrid vehicle are described; the vehicle is driven by an internal combustion engine (7) and/or an electric motor (5) as specified by an operating controller (1); the percentage contribution of the electric motor drive is controlled as a function of data which pertains to the travel route and is reported to the operating controller (1), taking into account a state of charge (BL) of an energy accumulator (4) for electric power. Control which is advantageous with regard to consumption and utilization of power is achieved by the fact that this data includes altitude information, which is used as the basis for controlling the percentage contribution of the electric motor drive, and the charge of the energy accumulator (4) does not drop below a minimum state of charge level (ML) at which essential basic vehicle functions are still ensured, as defined in the operating controller (1).

### FIELD OF THE INVENTION

The present invention relates to a method of triggering a hybrid vehicle driven by an internal combustion engine and/or an electric motor according to the specification of an operating controller, where the percentage contribution of the electric motor drive is controlled as a function of data pertaining to the travel route, said data being reported to the operating controller, taking into account a charge state of an energy accumulator for electric power, as well as to a hybrid vehicle having a device for implementing such a method.

### BACKGROUND INFORMATION

German Published Patent Application No. 198 07 291 describes a method of operating a motor vehicle having a hybrid drive, instantaneous position data of the motor vehicle detected by a navigation system, for example, is compared with stored data from a road map to control the percentage contribution of the electric motor drive as a function of the traffic environment. In this case, a charge state of a battery of the hybrid drive is monitored continuously. In particular, the information regarding the traffic environment pertains to the differentiation between driving in a city or driving on the highway and also information regarding the distance from an electric service station.

U.S. Pat. No. 5,892,346 describes a hybrid vehicle, in which position data supplied by a navigation system is taken into account in controlling the percentage contribution of the electric motor drive.

### SUMMARY OF THE INVENTION

An object of the present invention is to provide a method and a hybrid vehicle for implementing the method of the present invention, using which better utilization of electric power in particular is achieved.

According to the present invention, the data includes altitude information, which is used as the basis for controlling the percentage contribution of the electric motor drive, where the charge of the energy accumulator does not drop below a minimum level which is defined or definable in the operating controller and is necessary to still ensure basic vehicle functions. In the case of the hybrid vehicle, the object is achieved by the fact that the device has a unit for obtaining altitude information; an analyzer unit for analyzing data of the altitude information supplied to it is provided in the operating controller, and a control part for controlling the percentage contribution of the electric motor drive on the basis of the altitude information is also provided in the operating controller.

Control based on altitude information yields the advantage that a lower minimum state of charge is used, i.e., more power may be taken from the energy accumulator for the electric motor drive, because in the subsequent downhill travel a calculable energy recovery for recharging the energy accumulator is made possible via the electric motor acting as a generator. The altitude to be expected may be taken into account in the altitude information. Charging and discharging of the battery may be optimally adjusted to the altitude topography, thus yielding advantages in consumption. Another advantage is that the electric motor of the parallel hybrid vehicle is used to a greater extent when driving uphill, thus making it possible to achieve improved torque characteristics.

Relatively accurate regulation of the percentage contribution of the electric motor drive and/or the charging and discharging processes of the energy accumulator is made possible by the fact that the altitude information includes the greatest altitude of the travel route or a partial travel route as well as the instantaneous altitude of the vehicle.

A favorable design and control sequence are achieved by the fact that the altitude information is obtained from data from a navigation system or some other suitable predictive system, e.g., GPS.

An advantageous procedure is to create an altitude profile of the travel route to the destination when inputting a destination location into the navigation system and to use this altitude profile data for controlling the percentage contribution of the electric motor drive so that the charge does not drop below the minimum state of charge on reaching the greatest altitude of a partial travel route and/or the total travel route.

Low consumption is supported by the fact that when driving downhill, the electric drive is operated in at least some sections of the downhill stretch as a generator driven by the vehicle wheels to supply a charging current to the energy accumulator, and when driving uphill, the input charging current is taken into account in advance in controlling the percentage contribution of the electric motor drive.

According to an alternative advantageous procedure, in the case of no input of a destination into the navigation system running in the background, the system recognizes a travel route selected by the driver and supplies altitude profile data for this travel route, this data being sent to the operating controller, and the percentage contribution of the electric motor drive is controlled by taking into account the next following greatest altitude and/or the greatest altitude of the total profile of the travel route.

Even without a navigation system or in the presence of a navigation system which is unable to supply altitude information, according to an advantageous embodiment the altitude information includes an information component stored in the operating controller in advance, including a greatest altitude of at least one partial travel route and/or of a total travel route and an instantaneous information component detected by using an altimeter; the instantaneous altitude obtained from the instantaneous information component is compared with the stored information component; and the percentage contribution by the electromagnetic drive is controlled on the basis of the result of this comparison.

Improved control and/or regulation of the drive is made possible by the fact that the minimum state of charge is determined adaptively in the operating controller as a function of an outside temperature, a time of day, the (general) battery condition or driving performance or a combination of at least two of these parameters.

A normal control concept for flat terrain may be tied into this by using a defined or predefinable minimum state of charge as the basis for the control along the entire travel route or by setting an altitude threshold in the operating control, such that when the altitude is below this threshold, the percentage contribution of the electric motor drive is that used in normal operation with a defined or definable minimum state of charge and, when the latter is exceeded, the percentage contribution of the electromagnetic drive is that used in the case of a minimum state of charge that is below the normal minimum state of charge.

### BRIEF DESCRIPTION OF THE DRAWINGS

FIG. 1 shows a block diagram of the structure of a control device for a hybrid motor.

FIG. 2 shows different battery charge states and performance demands of an electric motor with respect to an altitude profile.

FIG. 3 shows a flow chart for a method of triggering a hybrid vehicle.

### DETAILED DESCRIPTION

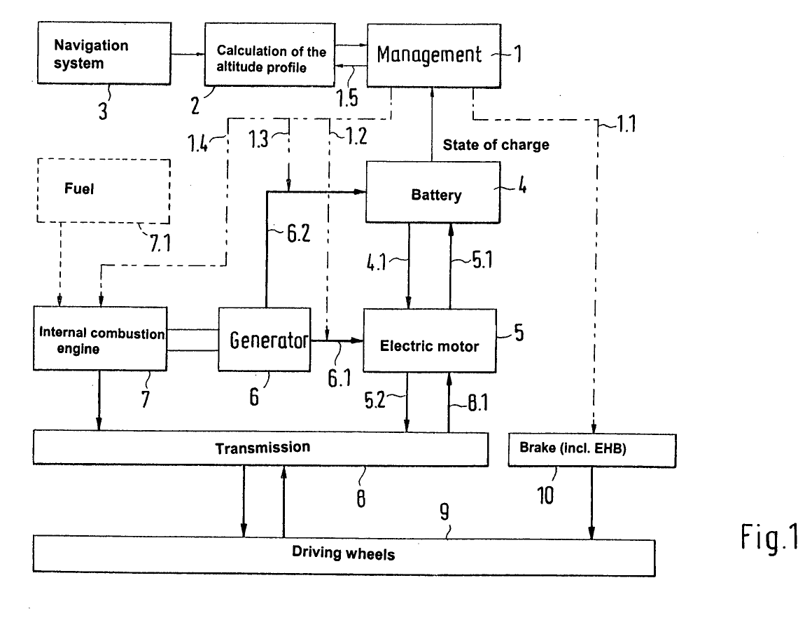

The device shown in FIG. 1 for controlling and/or regulating a parallel hybrid vehicle includes an operating controller 1 which receives altitude information from a navigation system 3 via a calculation unit 2 for calculation of an altitude profile, an internal combustion engine 7 supplied with fuel from a fuel tank 7.1 and driving a generator 6, an electric motor 5 supplied by generator 6 and an energy accumulator in the form of a battery 4, a transmission 8 driven by internal combustion engine 7 and/or electric motor 5, driving wheels 9 and brakes 10, which cooperate with the wheels, in particular electrohydraulic brakes. Operating controller 1 may be depicted, e.g., together with calculation unit 2 and navigation system 3 in a common control unit, e.g., including navigation system 3 itself or in a vehicle computer.

Electric motor 5 is driven by electric power received from the battery via motor power supply 4.1 and/or from generator 6 via a power supply 6.1 for generating mechanical driving energy 5.2, which acts on transmission 8. Conversely, electric motor 5 may be operated as a generator for power recovery, e.g., in braking operations and/or when driving downhill, in which case kinetic energy is supplied to it via an energy recovery 8.1 from driving wheels 9 via transmission 8. A resulting charging current 5.1 is used to charge battery 4. Furthermore, battery 4 may also be charged with generator 6 via a battery supply 6.2.

Operating controller 1 controls the percentage contribution of electric motor drive and/or the internal combustion engine via an electric motor control 1.2 and/or an internal combustion engine control 1.4 according to defined programs, the altitude information received by it via a data exchange 1.5 also being included in the calculations. Brake control 1.1 and charging control 1.3 of battery 4 are also accomplished by operating controller 1. The state of charge of battery 4 is reported to operating controller 1.

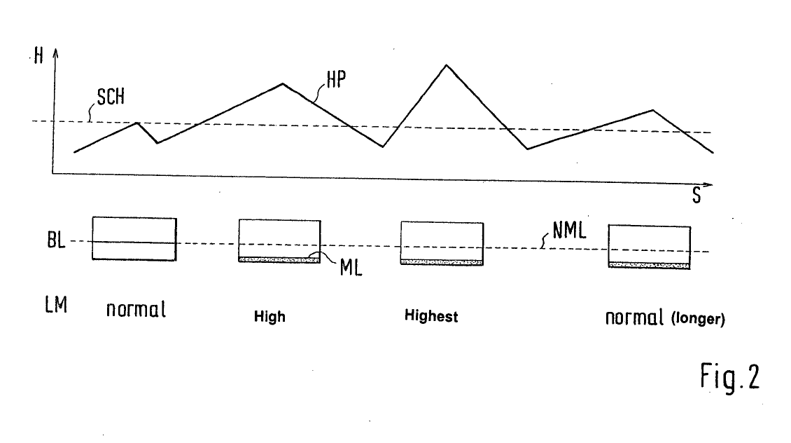

As shown in FIG. 2, an altitude profile HP over distance s may be determined from data from navigation system 3 by calculation unit 2. At a certain altitude, an altitude threshold SCH may be defined in operating controller 1 to implement control according to normal operation below this threshold and control on the basis of the altitude information above this threshold. With regard to minimum state of charge ML, below which the charge must not fall and which is adequate to ensure the basic electric functions of the vehicle, battery state of charge BL depends on threshold SCH, as well as on altitude profile HP; the general condition of the battery may also be taken into account. A regulating tolerance (target tolerance) may be selected, depending on the condition of the battery. If the altitude of altitude profile HP is below threshold SCH, a normal minimum state of charge NML is assumed in normal operating controller 1 as the basis below which the charge will not drop, i.e., the percentage contribution of the electric motor drive is controlled accordingly. However, if altitude H is above threshold SCH, then when driving uphill, the percentage contribution of the electric motor drive, i.e., power demand LM of electric motor 5, is increased by operating controller 1, a minimum state of charge ML of battery 4 which is below normal minimum state of charge NML being assumed as the basis, because it may be assumed that a downhill drive will then follow over a certain distance during which it will again be possible to recover charging power for battery 4. This makes it possible for an increased power to be made available by the hybrid drive while making the least possible use of internal combustion engine 7. The power demand on electric motor 5 may be determined as a function of the steepness, altitude, distance, and/or the following gradient.

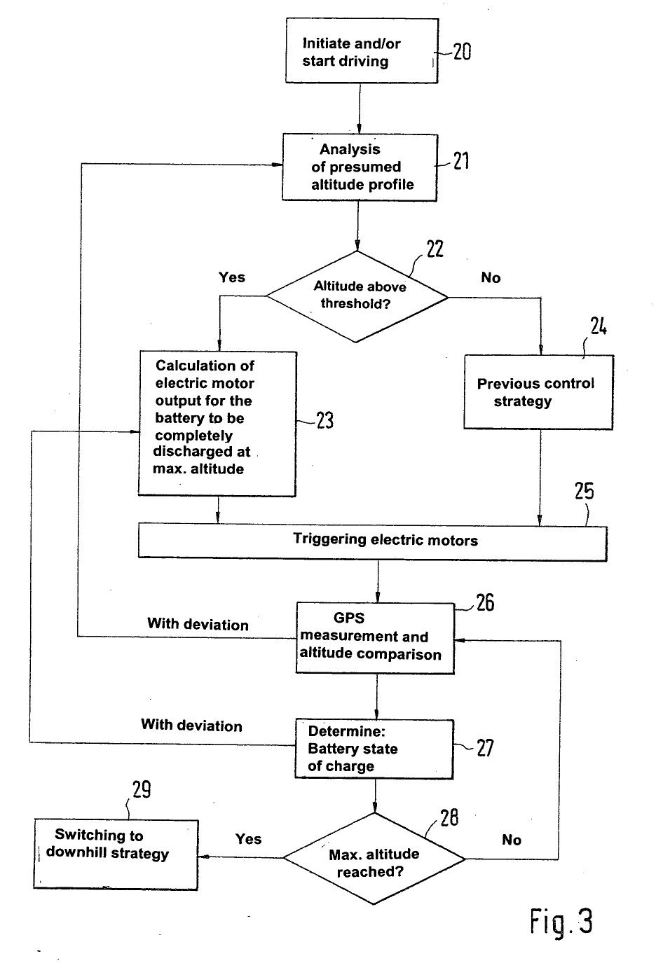

FIG. 3 shows an example of a flow chart, method steps 20 through 29 being shown in greater detail. First in a step 20, the system is initiated, i.e., the trip is begun, by operating controller 1. For example, a destination location may be input into navigation system 3, or the navigation system may run in the background. In a step 21, an anticipated altitude profile is analyzed and may also be updated when there is a change in a travel route initially taken. In a subsequent step 22, a check is performed to determine whether or not altitude H is above threshold SCH. If the threshold is exceeded, then in a step 23, the percentage contribution of electric motor control is calculated so that on reaching a maximum altitude H of a partial travel route or a total travel route, minimum state of charge ML is approximately reached. Electric motor 5 is triggered accordingly. If the charge falls below threshold SCH, a previous normal control strategy is retained in a step 24, and battery 4 is not discharged below normal minimum state of charge NML. The percentage contribution of the electric motor drive is controlled accordingly. Then in a step 26, the measured altitude is compared with the altitude according to the navigation system, and if a deviation is found, the system jumps back to step 21 with a new analysis of the anticipated altitude profile. If there is no deviation, then in a step 27 the battery charge is detected and checked. If there is a deviation, the system returns to step 23 and the output of electric motor 5 is calculated again. If there is no deviation of the battery state of charge, a check is performed to determine whether the greatest altitude has been reached and, if necessary, the system switches in a subsequent step 29 to a strategy for driving downhill, selecting a suitable energy recovery, e.g., including brake control 10. If the greatest altitude has not yet been reached, the system jumps back to step 26 and the corresponding method sequence is repeated.

The control via operating controller 1 may also be accomplished with the altitude information without using an altitude threshold SCH, in which case minimum state of charge ML is used as the basis for the calculations for the entire travel route.

Minimum state of charge ML need not be fixedly defined in operating controller 1, but instead may also be selected adaptively as a function of external parameters, e.g., as a function of an outside temperature, the time of day, the general battery condition or driving performance, because at a lower outside temperature, for example, greater electric power must be made available to battery 4 to ensure basic finctions. Depending on the time of day or the lighting conditions, there may also be different power demands to be taken into account. Depending on the driving performance, the power demand or energy recovery may also be different in comparison with an average performance. Minimum state of charge ML may also be made to depend on the greatest altitude of a partial travel route or the total travel route. The control or regulation strategy may depend on whether a destination has been input into navigation system 3 or whether the navigation system is running in the background. Tolerance bands may also be allowed for minimum state of charge ML and normal minimum state of charge NML.

If the hybrid vehicle does not have a navigation system or an information system capable of providing altitude information, then operating controller 1 may be designed to permit loading in advance, e.g., manually or from a data storage device having altitude information for a planned travel route, and to be capable of receiving instantaneous altitude data from an altimeter during the trip. In an analyzer device, the altitude information and altitude data may then be calculated as in the preceding exemplary embodiment for controlling the percentage contribution of the electric motor drive. Here again, different control strategies may be used with corresponding programs which are then used via a control part of operating controller I for the control.

What is claimed is:

1. A method of triggering a hybrid vehicle, which is driven by an internal combustion engine (7) and/or an electric motor (5) as specified by an operating controller (1), the percentage contribution of the electric motor drive being controlled as a function of data pertaining to the travel route and reported to the operating controller (1), taking into account a state of charge (BL) of an energy accumulator (4) for electric power,
wherein the data includes altitude information, which is used as the basis for controlling the percentage contribution of the electric motor drive, and the charge of the energy accumulator (4) does not drop below a minimum state of charge (ML), defined or definable in the operating controller (1), at which essential basic vehicle functions are still ensured.

2. The method as recited in claim 1,
wherein the altitude information includes the maximum altitude of the travel route or a partial travel route as well as the instantaneous altitude of the vehicle.

3. The method as recited in claim 1 or 2,
wherein the altitude information is obtained from data of a navigation system (3) or some other predictive system.

4. The method as recited in one of the preceding claims,
wherein an altitude profile of a travel route to a destination location is created when a destination location is input into the navigation system (3), and the altitude profile data is used for controlling the percentage contribution of the electric motor drive in such a manner that on reaching the greatest altitude of a partial travel route and/or the total travel route, the charge does not drop below the minimum state of charge (ML).

5. The method as recited in claim 4,
wherein when driving downhill, the electric drive (5) is operated in at least some sections as a generator driven by the vehicle wheels for inputting a charging current (5.1) into the energy accumulator (4), and when driving uphill, the input charging current (5.1) is taken into account in advance in controlling the percentage contribution of the electric motor drive.

6. The method as recited in one of claims 1 through 3,
wherein when no destination is input into the navigation system (3) running in the background, the navigation system recognizes a selected travel route and supplies altitude profile data on this travel route to the operating controller (1); and
the percentage contribution of the electric motor drive is controlled by taking into account the next following greatest altitude and/or the greatest altitude of the total profile of the travel route.

7. The method as recited in claim 1 or 2,
wherein the altitude information is composed of an information component stored in advance in the operating controller, including a maximum altitude of at least one partial travel route and/or of a total travel route, and an instantaneous information component detected by an altimeter; the instantaneous altitude obtained from the instantaneous information component is compared with the stored information component; and on the basis of the result of this comparison, the percentage contribution of the electromechanical drive is controlled.

8. The method as recited in one of the preceding claims,
wherein the minimum state of charge (ML) is determined adaptively in the operating controller (1) as a function of an outside temperature, a time of day, a battery condition and/or the driving performance or a combination of at least two of these parameters.

9. The method as recited in one of the preceding claims,
wherein the defined or definable minimum state of charge (ML) along the entire travel route is used as the basis for the calculations, or an altitude threshold (SCH) is set in the operating controller (1) so that when the altitude is lower than this threshold, the percentage contribution of the electric motor drive is that used in normal operation with a defined or definable normal minimum state of charge (NML), and when the altitude exceeds this threshold, the percentage contribution of the electromagnetic drive is that used in the case of the minimum state of charge (ML), which is below the normal minimum state of charge.

10. A hybrid vehicle having an internal combustion engine (7) and an electric motor (5) which is supplied with electric power from an energy accumulator (4), and also having a device for implementing the method as recited in one of the preceding claims, the device having an operating controller (1) for controlling the percentage contribution of the electric motor drive,
wherein the device has a unit for obtaining altitude information;
an analyzer unit for analyzing data on altitude information supplied to it, and a control part for controlling the percentage contribution of the electric motor drive on the basis of this altitude information are provided in the operating controller (1).
